(19) United States
(12) Patent Application Publication
(10) Pub. No.: US 2023/0099132 A1
(43) Pub. Date: Mar. 30, 2023

(54) MEDIATION SYSTEM, MEDIATION METHOD, AND RECORDING MEDIUM

(71) Applicant: NEC Corporation, Minato-ku, Tokyo (JP)

(72) Inventor: Masato Ogura, Tokyo (JP)

(73) Assignee: NEC Corporation, Minato-ku, Tokyo (JP)

(21) Appl. No.: 17/792,573

(22) PCT Filed: Jan. 28, 2021
(86) PCT No.: PCT/JP2021/003007

§ 371 Date: Jul. 13, 2022

(30) Foreign Application Priority Data
Jan. 28, 2020 (JP) 2020-011617

(51) Int. Cl. G06Q 10/20; G06Q 30/0283

(52) U.S. Cl. CPC G06Q 10/20; G06Q 30/0284

(57) ABSTRACT

A mediation system includes a notification unit. The notification performs process of extracting a second device requiring maintenance where maintenance work can be performed along with a first device requiring maintenance work, the second device having a second manager differing from a first manager of the first device, and notifying the second manager as a consignee candidate of the maintenance work of the first device.

### TECHNICAL FIELD

The present invention relates to a mediation system, a mediation method, and a recording medium.

### BACKGROUND ART

With the development of networks, systems for connecting a plurality of contractors have been proposed. These systems have been proposed for cost reduction and operational efficiency. Patent Document 1 discloses an electronic commerce system for reducing operating costs and the like by allowing another company to take over the work handled by one's company in order to reduce costs. Further, Patent Document 2 discloses a contractor mediation support system that allows a plurality of contractors to register and that can select a contractor that meets the desired conditions from among the registered contractors.

### PRIOR ART DOCUMENTS

### Patent Documents

Patent Document 1: Japanese Unexamined Patent Application, First Publication No. 2004-021965

Patent Document 2: Japanese Unexamined Patent Application, First Publication No. 2002-123703

### SUMMARY OF THE INVENTION

### Problems to be solved by the Invention

With the development of networks, the number of IoT (Internet of Things) devices that can be connected to networks is rapidly increasing. Most IoT devices are sensor devices. For example, as IoT devices, battery-powered sensor devices such as water level sensors for measuring the water level of rivers and soil sensors used in agriculture are being used. And in the near future, it is predicted that sensor devices as IoT devices will be widely installed. Such devices require maintenance work such as for malfunctions and battery replacement. Therefore, when IoT devices are widely used, it is necessary to dispatch a person for maintenance work, whereby the work load increases, and the cost burden associated therewith increases. The increase in work load and cost burden can be solved by requesting another contractor to perform the work. Therefore, a system for connecting multiple contractors is important.

However, the above-mentioned electronic commerce system and contractor mediation support system cannot automatically extract contractors who are candidates for consignment of work according to the need for device maintenance, or mediate to request other contractors to carry out device maintenance work.

Therefore, one example object of the present invention is to provide a mediation system, a mediation method, and a program for a mediation system that solves the above problems.

### Means for Solving the Problems

According to the first example aspect of the present invention, a mediation system includes: a notification means that extracts a second device requiring maintenance where maintenance work can be performed along with a first device requiring maintenance work, the second device having a second manager differing from a first manager of the first device, and notifies the second manager as a consignee candidate of the maintenance work of the first device.

According to the second example aspect of the present invention, a mediation method executed by a computer includes: extracting a second device requiring maintenance where maintenance work can be performed along with a first device requiring maintenance work, the second device having a second manager differing from a first manager of the first device, and notifying the second manager as a consignee candidate of the maintenance work of the first device.

According to the third example aspect of the present invention, a recording medium that stores a program for a mediation system that: extracts a second device requiring maintenance where maintenance work can be performed along with a first device requiring maintenance work, the second device having a second manager differing from a first manager of the first device, and notifies the second manager as a consignee candidate of the maintenance work of the first device.

### Effects of the Invention

According to an example embodiment of the present invention, a second device requiring maintenance where the maintenance work can be performed along with a first device requiring maintenance work is extracted, the second device having a second manager differing from a first manager of the first device; and the second manager is notified as a consignee candidate of the maintenance work of the first device. This makes it possible to automatically extract a contractor who is a candidate for consignment of work according to the need for device maintenance, and also enables mediation for requesting another contractor to carry out device maintenance work.

### BRIEF DESCRIPTION OF THE DRAWINGS

FIG. 1 is a diagram showing an overall configuration including a mediation system according to an example embodiment of the present invention.

FIG. 2 is a block diagram showing a configuration of the mediation system according to the example embodiment of the present invention.

FIG. 3 is a diagram showing the hardware configuration of the mediation system according to the example embodiment of the present invention.

FIG. 4 is a diagram showing an example of the operation of registration of a contractor who uses the mediation system according to the example embodiment of the present invention.

FIG. 5 is a diagram showing an example of operation of the mediation system according to the example embodiment of the present invention.

FIG. 6 is a diagram showing an example of the display on a computer system of a contractor who is a consignee candidate by the mediation system according to the example embodiment of the present invention.

FIG. 7 is a diagram showing the configuration of the mediation system according to the example embodiment of the present invention.

### EXAMPLE EMBODIMENT

Hereinbelow, a mediation system according to an example embodiment of the present invention will be described with reference to the drawings. FIG. 1 is a diagram showing the overall configuration including a mediation system 1 according to this example embodiment. FIG. 1 shows the mediation system 1 and a network 2.

The mediation system 1 performs a process to extract and notify a consignee of maintenance work of a device that requires maintenance work by detecting that maintenance work of a device connected to a network such as an IoT device is required.

The network 2 connects another device and the mediation system 1 by wire or wirelessly. Computer systems of a plurality of contractors A, B, C, . . . , X, . . . are connected to the network 2. Further, the computer systems of vendors A, B, . . . that provide parts and the like for the maintenance of the device are also connected to the network 2.

In this example embodiment, as an example, the IoT device to be maintained is a sensor device such as a water level sensor for measuring the water level of a river or a soil sensor used in agriculture and installed over a wide area, being a battery-powered sensor device. As the maintenance work, replacement of the batteries in these sensor devices will be described as an example.

It is assumed that contractor A, contractor B, contractor C, . . . are responsible for maintaining the above-mentioned devices. In addition, it is assumed that each contractor A, B, C, . . . has the responsibility of managing one or more different devices. Each contractor A, B, C, . . . manages information about the devices managed by themselves, for example, the type of the device, the installation position information, the type of battery to be used, and the like, with a computer system. Moreover, it is assumed that the computer system of each contractor A, B, C, . . . can acquire information detected by the device managed by the respective contractor via the network 2 or via a different network, and can manage the state of the device. The state of the device includes the remaining battery level, the device malfunction, and the like.

Contractor X, . . . is a contractor who specializes in the maintenance of the above-mentioned devices and the like, without having a device to be managed and maintained by itself. Vendors A, B, . . . are vendors capable of providing batteries and parts for devices managed by contractors A, B, C, . . . .

The above-mentioned devices to be maintained, maintenance contents as well as contractors and vendors are merely examples for explaining the present example embodiment, and are not limited thereto. Further, in the following description, the computer system of contractor A, the computer system of the contractor B, the computer system of the contractor C, the computer system of the contractor X, and the like may be simply referred to as contractors A, B, C, and contractor X. Similarly, the computer system of vendor A and the computer system of vendor B may be simply referred to as vendors A, B, and so on.

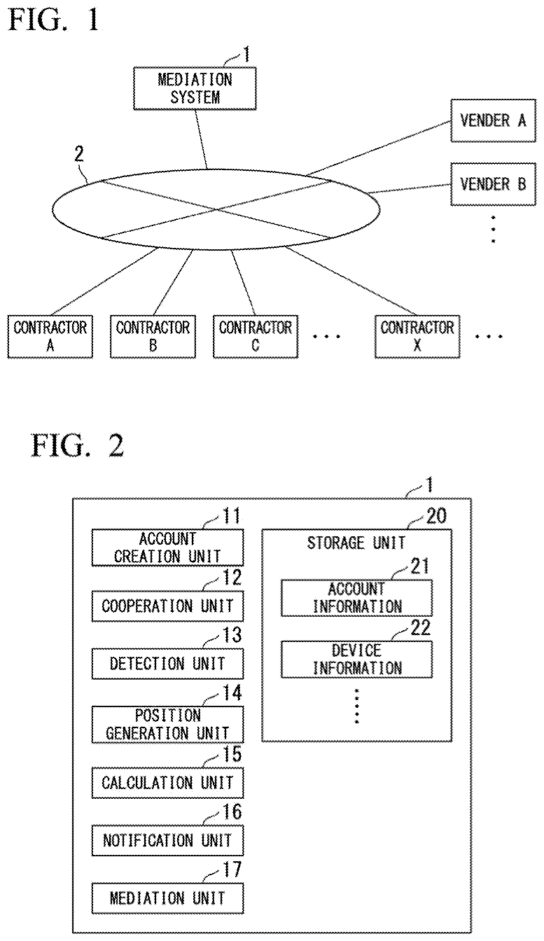

FIG. 2 is a block diagram showing a configuration of a mediation system 1 according to the example embodiment of the present invention. The mediation system 1 includes an account creation unit 11, a cooperation unit 12, a detection unit 13, a position generation unit 14, a calculation unit 15, a notification unit 16, a mediation unit 17, and a storage unit 20.

The storage unit 20 stores account information 21, device information 22, and other various pieces of information required for the operation of the mediation system 1.

The account creation unit 11 performs processing for account creation, registration, and maintenance so that a contractor who wants to consign or be consigned maintenance work can connect to the mediation system 1. The account creation unit 11 also performs processing for account creation, registration and maintenance so that a vendor who wants to provide parts, batteries, and the like for device maintenance to the registration contractor of the mediation system 1 can connect to the mediation system 1. The account information of the contractor and the vendor is stored in the storage unit 20 as the account information 21. The account information includes not only the ID and password for accessing the mediation system 1, but also access information such as the company name, address, e-mail address and telephone number, and information such as the address of a business establishment that serves as a base for maintenance work.

The cooperation unit 12 performs a process of extracting the information of the device managed by the registered contractor from the computer system of the registered contractor, and registering the information as device information 22 in the storage unit 20. For this reason, exchange of necessary information between the mediation system 1 and the computer system of the registered contractor is enabled via an API (Application Interface). The device information 22 includes information on the managing contractor, location information relating to a device installation position, the device type, information regarding the battery used in the device, and the like. Moreover, the device information 22 may include information such as when the battery is replaced, the battery replacement cycle, and the like.

The detection unit 13 detects any device registered in the device information 22 that requires maintenance work. An example of starting the detection process of a device that requires maintenance is as follows. For example, suppose there is detected the need to replace the battery of any device managed by the computer system of a registered contractor. The detection unit 13 performs the detection process by notifying the mediation system 1 of the detection information of the device requiring maintenance together with the information for identifying the target device by means of the computer system of the registered contractor. Alternatively, the detection unit 13 may detect a device in which maintenance is required by using the time in which the battery was required or the battery replacement cycle, being information registered as the device information 22. Further, the detection unit 13 may detect a device in which maintenance is required at regular intervals. Alternatively, the detection unit 13 may detect a device in which maintenance is required according to an instruction from the operator to the mediation system 1.

By searching the device information 22, the position generation unit 14 acquires the position information of the device requiring maintenance detected by the detection unit 13, and generates the device position information including the approximate position of the device requiring maintenance. Further, by searching for the device information 22, the position generation unit 14 acquires the position information about other devices that require maintenance, which is extracted by the notification unit 16 described later. Moreover, the position generation unit 14 also generates device position information including the acquired positions of other devices. The device position information is map information showing the installation position of the device or the approximate position where the device is installed. Further, the device position information may be text information such as the longitude and latitude or the address indicating the installation position of the device, or an area name indicating the approximate position of the device.

The calculation unit 15 calculates a reference offering price when a consignee candidate receives the consignment. The calculation unit 15 calculates the upper limit and the lower limit of the reference offering price using the position of the contractor consigning the maintenance work, the position of the contractor who is a consignee candidate, the position of the device to be maintained, the work time of maintenance, and the like, and determines the reference offering price using the upper limit price and the lower limit price.

When the detection unit 13 detects the necessity of maintenance of a device, the notification unit 16 extracts a contractor who is a consignee candidate of maintenance of this device using the information stored in the storage unit 20. Further, the notification unit 16, when notifying the contractor who is a consignee candidate of the maintenance work, also provides the device position information generated by the position generation unit 14. Moreover, the notification unit 16 notifies the contractor who is a consignee candidate of the reference offering price calculated by the calculation unit 15.

When a contractor who is a consignee candidate who has been notified by the notification unit 16 detects the input of the offer of a contract price for the consignment of maintenance work, the mediation unit 17 notifies the contractor who is the consignor of the contract application such as the contract price. The mediation unit 17, upon detecting the input of a consignment request from the contractor who is the consignor with respect to the contract application from the consignee candidate, notifies the consignee candidate who made the contract application to that effect. In addition, the mediation unit 17 also gives notice of detailed information relating to the position of the device whose maintenance work has been consigned, when notifying the consignee candidate who applied for the contract of the consignment request.

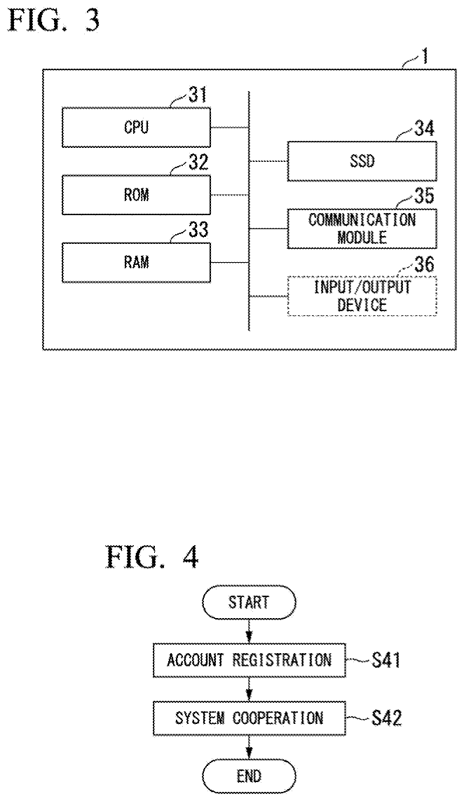

FIG. 3 is a diagram showing a hardware configuration of the mediation system 1 according to the example embodiment of the present invention. The mediation system 1 includes a CPU (Central Processing Unit) 31, a ROM (Read Only Memory) 32, a RAM (Random Access Memory) 33, an SSD (Solid State Drive) 34, and a communication module 35.

The CPU 31 realizes each function of the mediation system 1 by executing a program stored in a recording medium such as the ROM 32 or the SSD 34.

The SSD 34 also stores data and the like required to realize the function of the mediation system 1. The SSD 34 may be another non-volatile storage device, for example, an HDD (Hard Disk Drive), or may be configured by several different types of non-volatile storage devices. The communication module 35 is used for network connection. Further, the mediation system 1 may include an input/output device 36 as needed. The input/output device 36 is any or all of devices such as a keyboard, a mouse, a touch panel, and a display device.

FIG. 4 is a diagram showing an example of the operation of the initial setting of the mediation system 1 according to the example embodiment of the present invention. Referring to FIG. 4, the initial setting of the contractor who desires to use the mediation system 1 will be described.

When there is a request for registration to the mediation system 1 from a new contractor, the account creation unit 11 of the mediation system 1 processes account creation and registration so that the new contractor can use the service of the mediation system 1 (Step S41). The account creation unit 11 also performs an account creation and registration process in the same manner for a registration request from a vendor that desires to provide parts, batteries, and the like for device maintenance. At this time, the account creation unit 11 also performs processing for registration of the company name, address, location of maintenance staff, and the like, which are basic information of the contractor or vendor to be registered.

Next, the cooperation unit 12 performs a process of extracting the information of the device managed by the newly registered contractor from the computer system of the registered contractor and registering the information as the device information 22 in the storage unit 20 (Step S42). In this process, the cooperation unit 12 acquires the device information via the API that enables the cooperation between the mediation system 1 and the computer system of the contractor, and registers the device information in the storage unit 20.

The account creation unit 11 not only registers new contractors, but also performs processes for maintaining account information. When the cooperation unit 12 receives a notification of change, update or addition of the information of the device to be managed by the contractor from the computer system of the contractor, the cooperation unit 12 also performs the change, update or addition process on the device information 22.

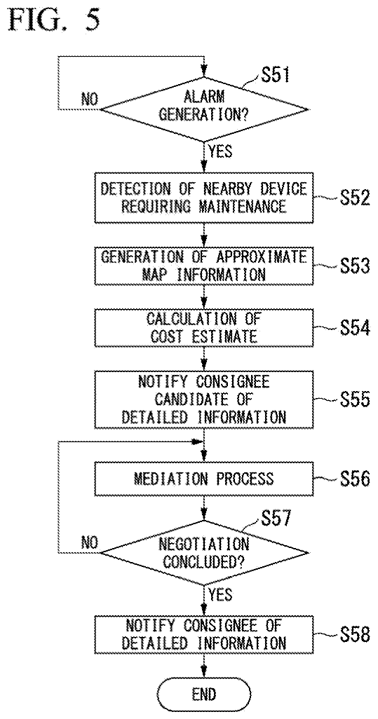

FIG. 5 is a diagram showing an example of an operation when mediating between a contractor who is a consignor and a contractor who is a consignee of the mediation system 1 according to the example embodiment of the present invention. Hereinbelow, the operation related to the mediation of the mediation system 1 will be described with reference to FIG. 5.

In the explanation of the operation of the mediation system 1, the case of a device to be newly maintained being detected in the following situations is also described.

Contractor A in FIG. 1 manages four devices (1), (2), (3), and (4) and is responsible for the maintenance thereof. Contractor B manages the two devices (5) and (6) and is responsible for the maintenance thereof. Contractor C manages the five devices (7), (8), (9), (10), and (11) and is responsible for the maintenance thereof.

Of the five devices managed by contractor C, three devices (7), (8), and (9) are already in a state where the respective batteries need to be replaced, but since there is residual capacity in each battery, the battery replacement work in devices (7), (8), and (9) has not been performed. The necessity of battery replacement work for the devices (7), (8), and (9) has already been ascertained by the mediation system 1 by the processing of the cooperation unit 12 of the mediation system 1, and is recorded in the device information 22 as status information.

In the above situation, it is assumed that an alarm indicating that battery replacement maintenance is required for the device (1) among the three devices managed by the contractor A is detected by the computer system for device management of contractor A. It is assumed that this detection result is also detected in the mediation system 1 via the API, and the mediation process by the mediation system 1 is started.

In the example, it is assumed that the installation positions of the device (1) of the contractor A which newly requires maintenance and the devices (7), (8), and (9) of the contractor C which require maintenance are within a range where the travel distance for maintenance work is not too far, or are located relatively close.

The detection unit 13 of the mediation system 1 performs a detection process of whether maintenance work is required on any of the devices registered in the device information 22 (Step S51). If none can be detected (Step S51: NO), the detection unit 13 returns to Step S51 and continues the detection process. On the other hand, when a device requiring maintenance is detected (Step S51: YES), the process proceeds to Step S52 for the next process.

In the above example, it is assumed that, when the necessity of battery replacement of the device (1) is detected by the computer system of the contractor A, the detection information thereof is also obtained by the detection unit 13 of the mediation system 1 via the network 2.

The notification unit 16 detects other devices on which maintenance work can be performed together with the device detected in Step S51, the other devices requiring maintenance and being managed by other contractors. Specifically, by searching the device information 22, the notification unit 16 detects other devices requiring maintenance that are close to the installation position of the device detected in Step S51. From the detection result, the notification unit 16 determines a consignee candidate of maintenance of the devices requiring maintenance (Step S52). In this process, it is assumed that the notification unit 16 performs detection of other devices requiring maintenance close to the installation position of the device detected in Step S51, the other devices requiring maintenance by a manager different from the manager of the device detected in Step S51. Thereby, the notification unit 16 selects both the owner of the device detected in Step S51 and the owner of the other devices requiring maintenance close to the installation location of the device detected in S51 as consignee candidates for the other's maintenance work. Alternatively, the notification unit 16 determines one of the owner of the device detected in Step S51 and the owner of the other devices requiring maintenance close to the installation position of the device detected in Step S51 to be a consignee candidate for the other's maintenance work.

The device to be detected is set to be a device that requires maintenance existing within a predetermined range from the device detected in Step SM.

Alternatively, in order to detect a consignee candidate of maintenance work, the notification unit 16 detects a device that requires maintenance closest to the device detected in Step SM and that is managed by another contractor. At this time, besides a device managed by the other contractor that was detected, the notification unit 16 may also detect devices requiring maintenance that are managed by this operator (the other operator) close to that device.

In the above example, it is assumed that the device (1) managed by the contractor A is newly detected as a device requiring maintenance in Step SM, while in Step S52, the notification unit 16 detects the three devices (7), (8), and (9) managed by the operator C. In this case, the notification unit 16 selects contractor C as a consignee candidate of maintenance work of the device of contractor A. The notification unit 16 may also select the contractor A as a consignee candidate of maintenance work of the devices of contractor C. Moreover, the notification unit 16 may select the contractor C as a consignee candidate of maintenance work of the device of contractor A, and may select contractor A as a consignee candidate of maintenance work of the devices of contractor C.

When the owner of another device that is close to the installation position of the device detected in Step SM and that requires maintenance is made a consignee candidate of maintenance work, the position generation unit 14 generates device position information to be provided to the consignee candidate (Step S53). In this process, first, the position generation unit 14 acquires the position information of the device detected in Step S51 by searching the device information 22. Then, the position generation unit 14 uses the position information of the device detected in Step S51 to generate device position information including the approximate position of the device. Further, the position generation unit 14 acquires position information about the other devices extracted in Step S52 by searching the device information 22. Then, the position generation unit 14 also generates device position information including detailed position of the other devices. In this way, the position generation unit 14 generates device position information to be presented to the consignee candidate. Moreover, the position generation unit 14 may generate the device position information so that it can be known who are the managers of the devices shown by the device position information.

In the abovementioned example, in Step S53, the position generation unit 14 generates device position information relating to the approximate position of the device (1) of contractor A and the exact location rather than approximate for the devices (7), (8), and (9) of contractor C, for the contractor C who is a consignee candidate. Further, the position generation unit 14 generates the device position information so that it can be understood that the manager of the device (1) is contractor A and the manager of the devices (7), (8), and (9) is contractor C.

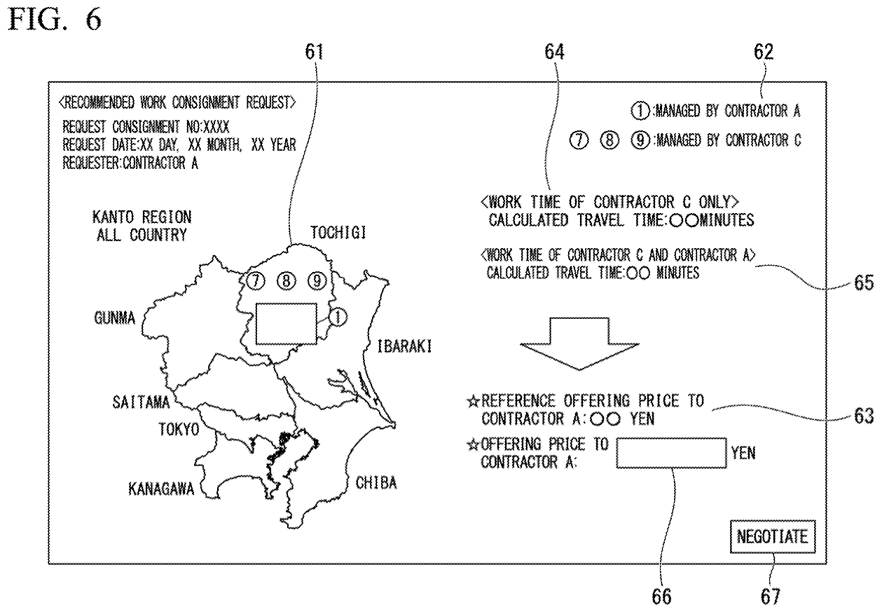

FIG. 6 is a diagram showing an example of a screen when the contractor C is selected as the consignee candidate of the maintenance of the device (1) of the contractor A and displayed as the consignee candidate in the computer system of the contractor C. Reference symbol 61 in FIG. 6 indicates an example of the device position information generated by Step S53. The example of FIG. 6 shows on the map the detailed (accurate) installation positions of the devices (7), (8), and (9) for which the contractor C is responsible for management and for which maintenance is required. Also shown on the map is a display example (approximate position) in which the detailed position of the device (1) that requires maintenance and for which contractor A, who is another contractor, is responsible for management is hidden. Moreover, FIG. 6 also shows a display example as denoted by reference symbol 62 as an example when showing that the manager of the device (1) is contractor A and the manager of the devices (7), (8), and (9) is contractor C. Thereby, a contractor who has been notified as being a consignee candidate can know the approximate positional relationship of another party's device with respect to his/her own device that requires maintenance, and can use that knowledge to determine whether or not to accept the consignment. Further, the contractor who has been notified as a consignee candidate can easily distinguish between devices managed by himself/herself and devices managed by other people.

When the contractor A is made a consignee candidate of the maintenance work of the contractor C in Step S52, the position generation unit 14 generates a detailed installation position for the device (1) of the contractor A in Step S53. Further, the position generation unit 14 generates device position information relating to the approximate position for the devices (7), (8), and (9) of the contractor C.

The example of FIG. 6 shows a screen example on the computer system of the contractor C when the contractor C is a consignee candidate, but when the contractor A is made a consignee candidate of the maintenance work of contractor C, a similarly generated screen may be presented to the computer system of contractor A. Further, when contractor C is selected as the consignee candidate of the maintenance work of the device of contractor A and contractor A is selected as the consignee candidate of the maintenance work of the devices of contractor C, in Step S53, the position generation unit 14 provides the device position information generated for the contractor A to the computer system of the contractor A. Moreover, the position generation unit 14 may provide the device position information generated for the contractor C to the computer system of contractor C.

The calculation unit 15 uses information such as the position information of the device requiring maintenance, the position information of the consignor of the maintenance work, the position information of the contractor who can be the consignee, the work time required for the maintenance of the device, and the like to calculate the reference offering price to be presented to the consignee candidate (Step S54). The reference offering price is calculated as follows.

The calculation unit 15 uses information such as the position information of the device requiring maintenance, the position information of the consignor of the maintenance work, the position information of the contractor who can be the consignee, the work time required for the maintenance of the device to calculate the following estimated costs:

1. Estimated cost (A) when the contractor who is the consignor performs maintenance work of a device that requires maintenance and is managed by the contractor himself/herself

2. Estimated cost (B) when the contractor who is the consignee candidate performs maintenance work of a device that requires maintenance and is managed by the contractor himself/herself

3. Estimated cost (C) when the contractor who is the consignee candidate performs maintenance work of a device that requires maintenance and is managed by the contractor himself/herself, and also performs maintenance work of a device that requires maintenance and is managed by the contractor who is the consignor

The calculation unit 15 determines the reference offering price using the upper limit price and the lower limit price, with the cost estimate (A) serving as the upper limit price and (cost estimate (C)−cost estimate (B)) serving as the lower limit price.

The reference offering price may be within the range of the upper limit price and the lower limit price, and may be, for example, the price in the middle of the upper limit price and the lower limit price. Further, the reference offering price may be calculated according to a predetermined calculation rule using the upper limit price and the lower limit price. For example, as a calculation rule, the reference offering price may be calculated using the remaining battery level of the device managed by the contractor who is the consignor as a parameter.

In the above example, it is assumed that the following information is available in order to calculate the reference offering price.

Personnel cost of each contractor: 7,500 yen/person-hour

Travel time from work location to device installation area (common to all companies): 1 hour

Device-to-device travel time: 5 minutes

Battery replacement work time per device: 10 minutes

In this case, the estimation results of the above-mentioned estimated costs (A) to (C) by the calculation unit 15 are as follows as an example.

(Case 1) When the contractor A replaces the battery only for device (1) by himself/herself

Overall battery replacement work time: 1 hour+10 minutes+1 hour=2 hours 10 minutes

Overall battery replacement work time (estimated cost A): 7,500 yen×2 hours 10 minutes=16,250 yen

(Case 2) When the contractor C replaces the batteries of only the devices (7), (8), and (9) by himself/herself

Overall battery replacement work time: 1 hour+(5 minutes×2)+(10 minutes×3 units)+1 hour=2 hours 40 minutes

Overall battery replacement work time (estimated cost B): 7,500 yen×2 hours 40 minutes=20,000 yen

(Case 3) When the contractor A consigns the work to the contractor C, and the contractor C replaces the batteries of the devices (1), (7), (8), and (9)

Overall battery replacement time: 1 hour+(5 minutes×3)+(10 minutes×4 units)+1 hour=2 hours 55 minutes

Overall battery replacement time (estimated cost C): 7,500 yen×2 hours 55 minutes=21,875 yen

Subsequently, the notification unit 16 extracts access information to the contractor who is a consignee candidate selected in Step S52 using the information stored in the storage unit 20. Then, the notification unit 16, when notifying the consignee candidate of the maintenance of the device, also gives notice of the device position information generated by the position generation unit 14. Moreover, the notification unit 16 notifies the contractor who is a consignee candidate of the reference offering price calculated by the calculation unit 15 (Step S55). The notification to the contractor who is a consignee candidate by the notification unit 16 may be only one of the device position information and the reference offering price. Further, as a notification to the contractor who is a consignee candidate by the notification unit 16, notification of one or both of the following work time estimates calculated by the calculation unit 15 may also be performed.

(Estimate A) Work time estimate required only for maintenance of devices managed by a contractor who is a consignee candidate

(Estimate B) Work time estimate when a contractor who is a consignee candidate performs maintenance of a device managed by himself/herself as well as maintenance of a device managed by the consignor

In the display example on the computer system of contractor C shown in FIG. 6, in Step S55, in addition to the device position information denoted by reference symbol 61, the reference offering price denoted by reference symbol 63 is also displayed. As a result, the contractor C can obtain reference information as the cost offering price when consigned the maintenance of the device (1) of the contractor A.

Moreover, FIG. 6 shows an example in which the following work time estimates are also presented as reference information.

(Estimate A) Work time estimate required for maintenance of devices (7), (8), and (9) by contractor C, denoted by reference symbol 64 (Estimate B) Work time estimate when the contractor C also performs maintenance of the device (1) in addition to (7), (8), and (9), denoted by reference symbol 65

Thereby, the contractor C can obtain additional information for determining the offering price, when presenting costs in the case of receiving a maintenance consignment of the device (1) of the contractor A.

Contractor A can also be a consignee candidate of maintenance work of a device to be maintained by contractor C. The mediation system 1 may perform the processes of steps S53 to S55 with the contractor C as the consignor and the contractor A as the consignee candidate. In this case, FIG. 6 is a display example in the computer system of the contractor C, but similar information as in FIG. 6 is presented to the computer system of the contractor A.

Subsequently, the mediation unit 17, upon detecting the notification of the presentation of the contract price for consignment of the maintenance work by a contractor who is a consignee candidate who received the notification in Step S55, notifies the contractor who is the consignor of the contract application of the contract price and the like (Step S56). At this time, the contractor who is a consignee candidate may also give notice of information relating to the work outline such as the scheduled day of the maintenance work together with the contract application.

In the example of FIG. 6, the operator of the computer system in the contractor C inputs the offer price when contracting the maintenance work of the device (1) in the field denoted by the reference symbol 66, and clicks the button denoted by the reference symbol 67. At this time, the computer system of the contractor C notifies the mediation system 1 of the contract application.

The mediation unit 17 manages negotiations relating to consigning and/or being consigned between the computer systems of the contractor who is the consignor and the contractor who is the consignee candidate. Then, the mediation unit 17 manages whether or not there is a notification of the consignment request for the contract application from the computer system of the contractor who is the consignor (Step S57).

If there is no notification of the consignment request (Step S57: NO), the mediation unit 17 continues to manage the negotiations regarding consigning and/or being cosigned between the computer systems of the contractor who is the consignor and the contractor who is the consignee candidate.

Upon detecting notification of the consignment request for the contract application from the computer system of the contractor who is the consignor (Step S57: YES), the mediation unit 17 notifies the consignee candidate who applied for the contract of the consignment request. At the time of this notification, the mediation unit 17 also gives notice of detailed information regarding the detailed position of the device to be maintained that is managed by the consignor (Step S58). With this notification, the contractor who is the consignee can acquire the detailed location of the device to be maintained managed by the consignor, make a detailed work plan including the maintenance work of the device to be maintained managed by the consignor, and can carry out the maintenance work.

By the notification in Step S58, in the above example, the contractor C can obtain detailed information regarding the position of the device (1).

With the above, the mediation system 1 ends the mediation process for the consignment of maintenance work for the device that requires maintenance work detected in Step S51.

In the case of the above example, if the cost estimate calculated by the calculation unit 15 is correct, the contractor A and the contractor C can obtain the following profits.

If the contractor C is entrusted with the maintenance work of the device (1) managed by the contractor A at the lower limit price calculated by the calculation unit 15, the contractor A can consign the work of 16,250 yen to the contractor C for 1,875 yen. As a result, the contractor A can reduce the costs related to the maintenance work of the device (1) by about 88%.

In addition, if the contractor C is entrusted with the maintenance work of the device (1) managed by the contractor A at the upper limit price calculated by the calculation unit 15, sales of up to 16,250 yen can be made for work of 1,875 yen. In this case, the contractor C has received an order for work with a profit margin of about 88%.

In Step 55 of FIG. 5, the notification unit 16 is described as notifying the contractor who is a consignee candidate of the reference offering price calculated by the calculation unit 15. In Step 55, the notification unit 16 may present to the contractor who is a consignee candidate the upper limit price and the lower limit price calculated by the calculation unit 15, or values close to those values, as the reference upper limit price and the reference lower limit price. The contractor who is a consignee candidate can refer to the upper limit price, lower limit price, reference upper limit price, and reference lower limit price in determining the price to be offered to the contractor who is the consignor.

In the explanation of the operation of the mediation system 1 with reference to FIGS. 5 and 6, an example is described in which a contractor who manages the device is extracted as a consignee candidate. The consignee candidate is not limited to a contractor that manages devices, and may be a contractor that specializes in maintenance work without managing devices, such as the contractor X shown in FIG. 1.

For example, in Step S52, in the case of there being no device that requires maintenance managed by another contractor near the device that requires maintenance, the notification unit 16 may select a contractor that specializes in maintenance work with a short travel time to the device that requires maintenance. At this time, in Step S53, the position generation unit 14 may generate information indicating the approximate position of the device requiring maintenance, or generate information indicating the detailed position of the device requiring maintenance. Further, in Step S54, the calculation unit 15 may calculate a cost estimate when a contractor who manages a device requiring maintenance performs maintenance work on the device, and based on this cost estimate, may calculate an amount multiplied by for example a coefficient of less than 100% as the reference offering price.

In the present example embodiment, the case where the contractor is one company and the consignee candidate is one company, or the case where both of these companies are the consignee candidates of a partner company have been described. Without being limited thereto, the contractor that is the consignor may be one company, and the contractors that are consignee candidates may be a plurality of companies. Moreover, the mediation system 1 may operate so that a contractor that is a consignee candidate can be entrusted with the maintenance work of a plurality of contractors that are consignors simultaneously.

The mediation system 1 may include a function of providing information on devices and parts, batteries, and the like thereof that can be provided by vendors A and B shown in FIG. 1 to a contractor that maintains the device, and a function for placing and receiving orders for those devices and parts, batteries and the like thereof between a contractor and the venders.

From the above, using the mediation system 1 eliminates the need for a contractor who manages a device to perform repair/replacement all at once when defects or battery exhaustion occurs in a certain number or more of devices from a cost aspect. In addition, a contractor who manages a device can smoothly consign maintenance work, and as a result, it is possible to eliminate issues such as a device that does not operate normally being left unattended for a certain period of time, and the possibility that the originally required measurement result may be lost. Furthermore, by using the mediation system 1, a contractor who owns a device that requires maintenance work such as repair of the device or battery replacement can collectively undertake the maintenance work of devices owned by another contractor, and so device maintenance work at a realistic cost becomes possible.

In addition, by using the mediation system 1, a contractor who consigns maintenance work can reduce the inefficient dispatch of workers, and can improve the operating rate of the device at low cost. Further, a contractor that is entrusted with the maintenance work of a device managed by another contractor can earn a profit by combining the entrusted work with the original work or solely undertaking the work.

The mediation system 1 can be used, for example, in a field where a large number of sensor devices are required to be installed over a wide range. For example, the mediation system 1 can be used in public sectors such as local governments where a large number of sensors are installed in rivers, mountainous areas, and towns to collect/utilize environmental information in order to aim for a smart city.

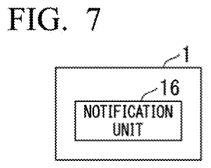

FIG. 7 shows the configuration of the mediation system 1 according to the example embodiment of the present invention. The mediation system 1 includes a notification unit 16.

The notification unit 16 performs a process to extract a second device requiring maintenance where the maintenance work can be performed along with a first device requiring maintenance work, the second device having a second manager differing from a first manager of the first device; and to notify the second manager of a consignee candidate of the maintenance work of the first device.

The above-mentioned mediation system 1 has a computer system inside. The process of the mediation system 1 described above is stored in a computer-readable recording medium in the form of a program, and the process is performed by the computer reading and executing this program. Here, the computer-readable recording medium means a magnetic disk, a magneto-optical disk, a CD-ROM, a DVD-ROM, a semiconductor memory, or the like. Further, this computer program may be distributed to a computer via a communication line, and the computer receiving the distribution may execute the program.

Further, the aforementioned program may be for realizing some of the above-mentioned functions. Further, the program may be a so-called differential file (differential program) that can realize the above-mentioned functions in combination with a program already recorded in the computer system.

This application is based upon and claims the benefit of priority from Japanese patent application No. 2020-011617, filed on Jan. 28, 2020, the disclosure of which is incorporated herein in its entirety by reference.

### INDUSTRIAL APPLICABILITY

The present invention may be applied to a mediation system, a mediation method, and a recording medium.

### DESCRIPTION OF REFERENCE SYMBOLS

1: Mediation system

2: Network

11: Account creation unit

12: Cooperation unit

13: Detection unit

14: Position generation unit

15: Calculation unit

16: Notification unit

17: Mediation unit

20: Storage unit

21: Account information

22: Device information

What is claimed is:

1. A mediation system comprising:
at least one memory configured to store instructions; and
at least one processor configured to execute the instructions to:
extract a second device requiring maintenance where maintenance work can be performed along with a first device requiring maintenance work, the second device having a second manager differing from a first manager of the first device; and
notify the second manager as a consignee candidate of the maintenance work of the first device.

2. The mediation system according to claim 1, wherein the at least one processor is configured to execute the instructions to:
generate device position information including an approximate position of the first device by using position information of the first device; and
when notifying the second manager as the consignee candidate of the maintenance work of the first device, also give notice of the generated device position information.

3. The mediation system according to claim 2, wherein the at least one processor is configured to execute the instructions to, when generating the device position information, generate the device position information including the approximate position of the first device and a position of the second device by further using position information of the second device and generates the device position information so that the manager of each device is distinguishable.

4. The mediation system according to claim 1, wherein the at least one processor is configured to execute the instructions to:
calculate a cost estimate when the first manager performs maintenance work on the first device, a cost estimate when the second manager performs maintenance work on the second device, and a cost estimate when the second manager performs maintenance work on the first device and the second device at same time, by using position information of the first device, the second device, and the second manager, and maintenance work time information of the first device and the second device;
calculate a reference offering price when the second manager accepts a consignment from the calculated cost estimates; and
when notifying the second manager as the consignee candidate of the maintenance work of the first device, also give notice of the calculated reference offering price.

5. The mediation system according to claim 4, wherein the at least one processor is configured to execute the instructions to:
set the cost estimate when the first manager performs the maintenance work of the first device as an upper limit price;
set a difference between the cost estimate when the second manager performs the maintenance work of the first device and the second device at the same time and the cost estimate when the second manager performs only the maintenance work of the second device as a lower limit price; and
determine the reference offering price by using the upper limit price and the lower limit price.

6. The mediation system according to claim 1, wherein the at least one processor is configured to execute the instructions to, upon detecting an offer input of a contract price for consignment of the maintenance work of the first device of the first manager by the second manager who has been notified, notify the first manager of a contract application including the contract price.

7. The mediation system according to claim 6, wherein the at least one processor is configured to execute the instructions to, upon detecting an input of a consignment request by the first manager with respect to the contract application, notify the second manager of detailed information of a position of the first device.

8. The mediation system according to claim 1, wherein the at least one processor is configured to execute the instructions to:
notify the first manager as a consignee candidate of the maintenance work of the second device instead of notifying the second manager as the consignee candidate of the maintenance work of the first device; or
notify the first manager as the consignee candidate of the maintenance work of the second device along with notifying the second manager as the consignee candidate of the maintenance work of the first device.

9. A mediation method executed by a computer, comprising:
extracting a second device requiring maintenance where maintenance work can be performed along with a first device requiring maintenance work, the second device having a second manager differing from a first manager of the first device; and
notifying the second manager as a consignee candidate of the maintenance work of the first device.

10. A non-transitory recording medium that stores a program for causing a mediation system to execute:
extracting a second device requiring maintenance where maintenance work can be performed along with a first device requiring maintenance work, the second device having a second manager differing from a first manager of the first device; and
notifying the second manager as a consignee candidate of the maintenance work of the first device.
